(19) United States
(12) Patent Application Publication
(10) Pub. No.: US 2017/0262263 A1
(43) Pub. Date: Sep. 14, 2017

(54) PROCESS AND SYSTEM FOR THE GENERATION OF AN OPERATING PROGRAM IN THE FORM OF A MOBILE APPLICATION THAT IS CAPABLE OF OPERATING ON A MOBILE DEVICE

(71) Applicant: SCHNEIDER ELECTRIC INDUSTRIES SAS, Rueil-Malmaison (FR)

(72) Inventors: Marcus ZINN, Rodgau (DE); Aurelien LE SANT, Aschaffenburg (DE)

(73) Assignee: SCHNEIDER ELECTRIC INDUSTRIES SAS, Rueil-Malmaison (DE)

(21) Appl. No.: 15/453,926

(22) Filed: Mar. 9, 2017

(30) Foreign Application Priority Data
Mar. 11, 2016 (EP) 16 159 885.9

(51) Int. Cl. G06F 9/44; G06F 9/445

(52) U.S. Cl. CPC G06F 8/35; G06F 8/60

(57) ABSTRACT

The invention relates to a process and a system for generating an operating program in the form of a mobile application (MAPP) that is capable of operating on a mobile device (MD) for interactions such as operation, monitoring, configuration and/or diagnosis with an application program (DA) of an automation device (D) for the control and/or monitoring of a machine (M) or installation. In order to permit a cost and time-effective generation of a mobile application for the operation, control and diagnosis of an automation device, with there being a requirement for special knowledge of the automation device as well as of the development of the mobile applications, it is foreseen that the mobile application (MAPP) is generated out of an application description (DAD) of the application program (DA) of the automation device.

The invention relates to a process for generating an operating program in the form of a mobile application that is capable of operating on a mobile device according to the general term of claim 1 as well as to a system for the carrying out of the process according to the general term of claim 9.

Hereinafter, when speaking of a mobile application, which can also be abbreviated as mobile app or simply app, one understands a software application that is developed to operate on a mobile device such as, for example, a smartphone or a tablet computer. Mobile applications are generally offered in so-called app-stores that are generally operated by the provider of the operating system, such as, for example, Apple® or Google®.

The development of a mobile application comprises a process, that delivers an application software for mobile devices. The mobile applications can either be pre-installed on the mobile device after generation, or else can be loaded by the user from an app-store on the mobile device.

In fields such as machine construction or automation technology, there is an increasing demand for Original Equipment Manufacturers (OEM) to prepare a mobile application for operation of an automation device controlling the machinery or installation by. The mobile application can either be created by the original equipment manufacturer themselves or by a contracted company. There also exists the possible to ask the manufacturer of the automation device whether a mobile application already exists or whether the same can be produced by the manufacturer.

The manual generation of a mobile application is, on the one hand, cost and time-intensive and, on the other hand, it requires a high degree of special knowledge relating to the development of mobile applications and their standards, as well as knowledge relating to technological aspects of the automation devices and the application programs running on them.

According to the state of the art, mobile applications are created either manually or by means of an application generator. As of now, application generators are however not able to create mobile applications for the control, monitoring or diagnosis of auto ion devices in a largely automated manner.

In WO 2013/134674 A1, a process and a system for the automated generation of a mobile application is described. The system is set out to process a request for the creation of a mobile application, whereby the request comprises provider-specific information relating to the application and provider-specific content for the mobile application.

A description of the mobile application (application description) is generated by means of a processing device on the basis of provider-specific application information, whereby the application description comprises a skeleton made up of one or a multitude of application features that is(are) to be implemented by the mobile application. The processing device initiates the generation process with a basic mobile application that is available in a data storage. The basic mobile application includes previously generated basic application software code. The basic mobile application is then subsequently modified by the processing device based upon the application description and, successively, a binary mobile application code is generated by the processing device for the mobile application with regards to the modified basic mobile application.

DE 10 2011 080 569 A1 refers to a system and a process for the operation of field equipment in an automation installation with a superordinate control/operation unit. The superordinate control/operation unit accesses the field devices by means of a communication network, whereby the communication network features a first bus system with a first transfer protocol on the control/operation level and a second bus level with a transfer protocol on the field level. The implementation of the two transfer protocols takes place in a gateway, whereby a basic software is foreseen in the gateway, which, upon occurrence of an event, detects field devices which are arranged on the field level by means of a search and uses the detected information through the field devices, so as to download the corresponding electronic device descriptions from an application server, in which server apps are maintained, and to make the control/operation unit available for operation of the field devices. The application server is made available to the clients by the device manufacturer or the device supplier. A variety of applications are offered on the applications server.

EP 2 905 946 A1 relates to a sensor with a control and analysis unit and a memory unit, whereby an application program is foreseen for the sensor for parametrization and/or diagnosis. An HTML-description is stored on the control unit, whereby the HTML-description contains an original download mechanism, whereby the original download mechanism is set out to transfer the application program to a browser on the end device and the application program can be started in the browser. It is possible that the advantages of a mobile device with a web application program can be used for configuration of the sensor and for commissioning of the sensor. The application program is laid out in such a way so that it reads a description of a user interface and dynamically establishes the user interface after the start up.

EP 2 863 277 A1 relates to a process for offline device simulation of a field device, in which at least one parameter of the field device is visualized and a parametrization of the field device is enabled and the device simulation is generated on the basis of a device description file and whereby the device simulation is carried out in a browser. The device simulation can be carried out on a computer platform of the browser, whereby one is dealing with a web application that is carried out on the client side. Additionally, the device simulation can be available as application software for mobile devices and/or as a browser plug-in.

Based upon the above, this invention assumes to further develop a process and a system of the aforementioned type in such a way so as to enable a cost and time-effective generation of a mobile application for operation, control and diagnosis of an automation device, without there being any need for special knowledge of the automation device as well as about the development of mobile applications.

This purpose is, among other things, solved according to the invention inasmuch as the mobile application is generated on the basis of an application description of the application program operating on the automation device.

Inasmuch as the application description already contains all information relating to the user interface, data, functions and structures of the application program, it is possible for the mobile application to be generated in a short time and in a substantially automated manner without any further involvement of the user of the automation device.

According to a preferred process, it is foreseen that the application description of the application program is loaded in an application generator system, which analyzes the application description as regards its structure and its content and breaks it down into segments, which are created out of the segments of the application description for the generation of the component descriptions needed by the mobile application, that the component descriptions, as regards the necessary application-specific software artifacts such as existing objects, existing modules, existing components or existing services and/or necessary mobile-device-specific software artifacts such as deployment rules and interdependencies are analyzed, that the necessary application-specific software artifacts and/or mobile-device-specific software artifacts are selected and are loaded from a data storage, that application components are created from the necessary application-specific software artifacts and/or the mobile-device-specific software artifacts, and that an executable source code for the mobile application is generated from the application components.

It has been shown to be particularly advantageous that, during the analysis of the application description, an application structure of the mobile application, an application type, an application environment and/or linker details can be derived, whereby an initially empty application skeleton can be created from the application structure, and that configuration files for the application components are created depending on the application skeleton and the component descriptions.

Furthermore, it is foreseen according to the invention that the executable code of the mobile application is created through the linking of the application components with the application skeleton.

It is foreseen according to a preferred process that, during the generation of the mobile application, user-specific information such as corporate identity, manufacturer name or user name and/or mobile-device-specific information such as details regarding the hardware or the mobile operating system are queried by an input prompt from the application description or are read from the mobile device upon linkage with the application generator system. It is thereby possible to formulate the mobile application according to the requirements of the original equipment manufacturer or the user.

It is foreseen according to a further preferred procedure that subsequent to the procedural step of the analysis of the application description, those components descriptions are selected by the user, through which user interfaces, functions, data and/or structures are described, upon which the user should act with the help of the mobile application. In this manner, the user is in the position to select the functions of the application program that are relevant to him/her and to thereby adapt the mobile application to his/her requirements.

The component descriptions preferably comprise at least a user interface component description, a data component description, a function component description as well as a structure component description. The component descriptions result from the analysis of the application description, in such a manner that the user interfaces, data, functions and structures that are defined in the application description can be displayed in a user-specific manner by the mobile application.

The application description is preferably an XML description. Notwithstanding this, other description formats can, however, also be used.

The invention further refers to a system for the generation of an operating program in the form of a mobile application that is capable of operating on a mobile device as regards interaction such as operation, monitoring, configuration and/or diagnosis with an application program of a automation device for the control and/or the monitoring of a machine or installation.

According to the invention, the application generator system comprises a code generator system with at least one transformation tool for the transformation of an application description of the application program of the automation device into application components, and an application generator for the generation of the mobile application on the basis of the application components.

It is foreseen, in a preferred embodiment, that the code generation system comprises a first transformation tool for the transformation of the application description of the application program into one or a multitude of component descriptions, as well as a second transformation tool for the transformation of the component descriptions while taking into account the application-specific software artifacts and/or mobile-device-specific software artifacts in the application components.

It is foreseen, in a further preferred embodiment, that the first transformation tool comprises an analysis module for the analysis of a structure and of the content of the application description, and to break down the application description into segments, as well as a component description creator for the creation of the component descriptions from the segments, whereby the component descriptions comprise at least one user interface components description, one data components description, one function components description, as well as one structure components description.

Preferably, the first transformation tool can feature a selection/download module for the selection and/or downloading of external application-specific information and/or mobile-device-specific information as well as for the selection and/or downloading of application-specific software artifacts as well as mobile-device-specific software artifacts from a databank. In this manner, already existing components descriptions can be loaded from external data storage.

On top of this it is foreseen that the second transformation tool comprises: an analysis module for the analysis of the needed component descriptions as regards existing user-specific software artifacts as well as mobile-device-specific software artifacts, as well as a selection/download module for the selection and for the downloading of necessary user-specific software artifacts as well as mobile-device-specific software artifacts from the at least one data storage.

For generation of an executable application code of the mobile application, the application generator features an application skeleton generator, a configuration file generator as well as a linker module, whereby the application skeleton generator creates an initially empty application skeleton from one of the application structures derived from the application description, the configuration file generator creates application components from the component descriptions in connection with the application skeleton configuration files and whereby the linker module links the configured application components with the application skeleton for the creation of the executable code of the mobile application (MAPP).

The mobile device is preferably a smart device such as, for example, a smartphone or a tablet computer.

Further details, advantages and features of the invention can be gleaned not only from the Claims, from the features that are derived from the same, on their own and/or in combination, but rather also from the following description of a preferred embodiment that is to be derived from the mosaics.

The figures show:

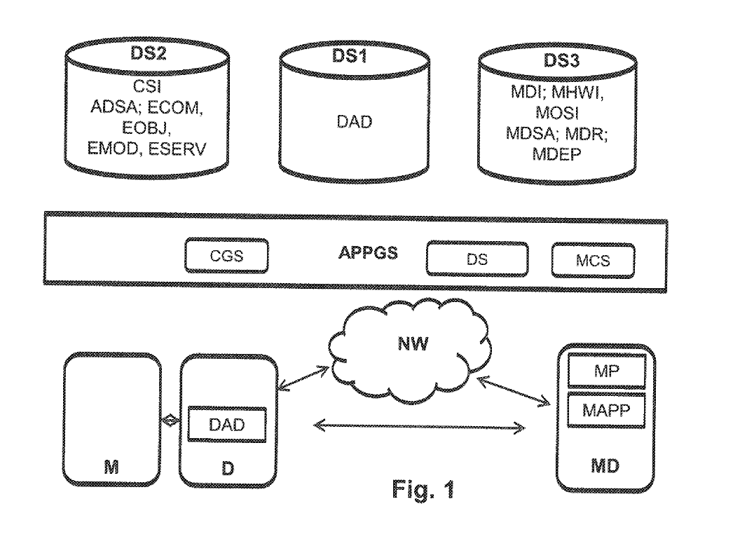

FIG. 1: a schematic representation of a system for the generation of a mobile application,

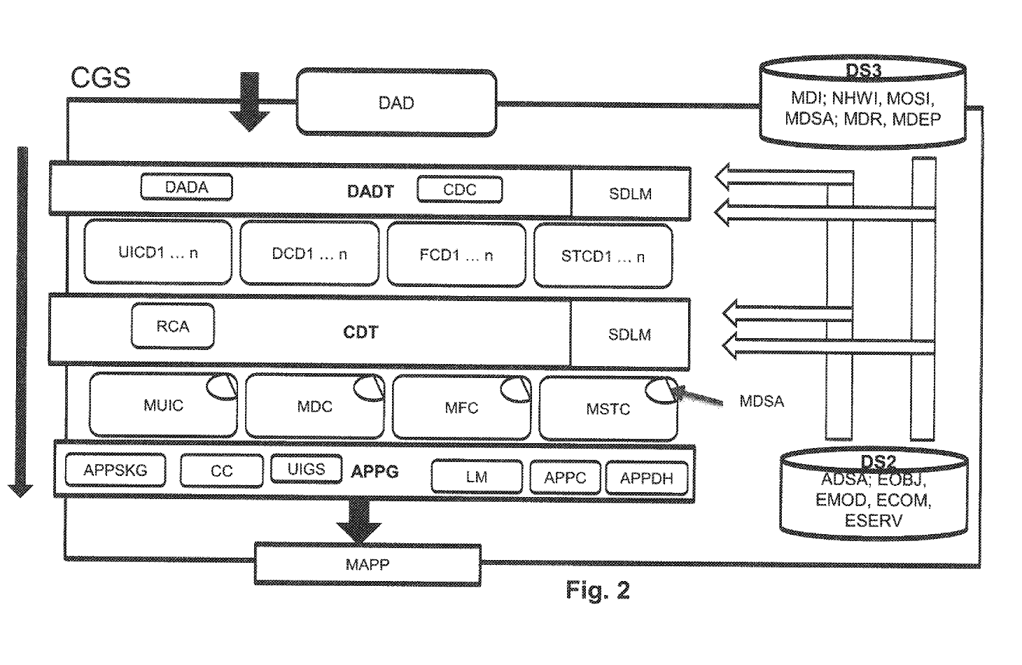

FIG. 2: a schematic representation of a code generator system,

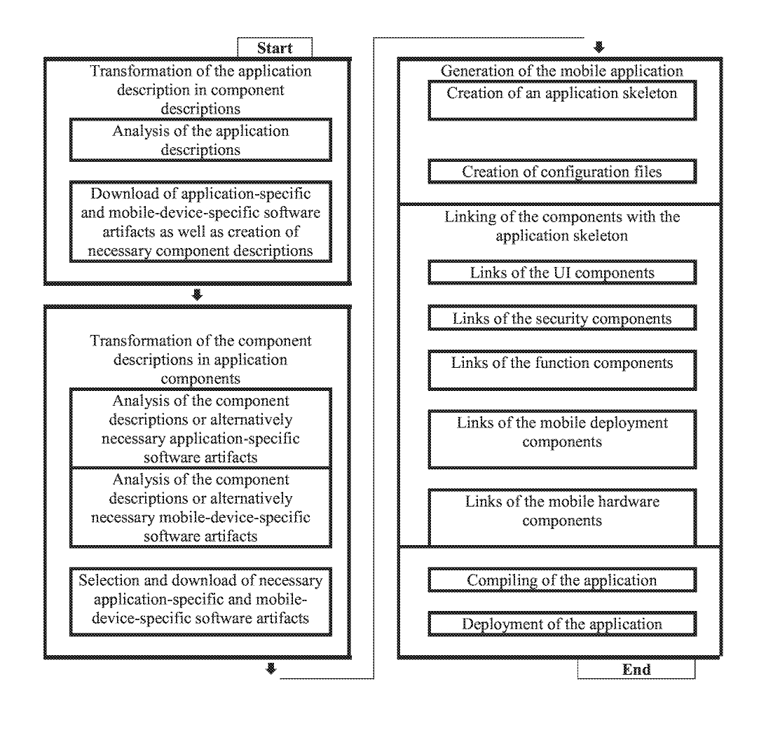

FIG. 3: a schematic methodology for the generation of a mobile application, and

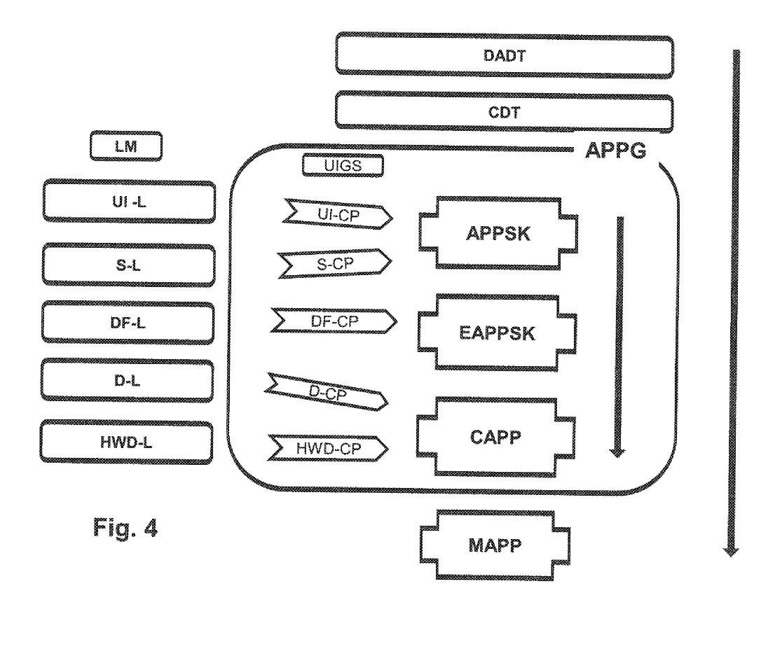

FIG. 4: a schematic representation of a component linker system.

FIG. 1 shows a system for the generation of an operating program in the form of an executable mobile application MAPP on a mobile device MD for the writing and reading of data in or from an application program DA running in an automation device D for the control of a machine M. It is foreseen according to the invention that the mobile application MAPP is generated by means of the automatic transformation of one application description DAD of the application program DA by means of an application generator system APPGS taking into account user-specific and/or mobile-device-specific input information CSI, MDI and existing software artifacts ADSA, MDSA.

The application description DAD, preferably a XML document, is stored in a data storage DS1 and includes an obligatory portion in the form of a document of the application description DAD as well as an optional portion in the form of a user-specific description. The user-specific description further details the application description DAD, for example, through specific parameters, to be able to better adapt the mobile application to the requirements of the user or the original equipment manufacturer.

For the generation of the mobile application MAPP, one requires the input information CSI, MDI, as well as the existing software artifacts ADSA, MDSA, which are downloadable in the data storages DS2, DS3, on top of the application description DAD.

Typical user-specific information CSI relates, for example, to the corporate identity as well as names of and information about specific users, so as to lay out a mobile application in a user-specific manner. The user-specific information is requested of the user during the automatic generation of the mobile application or automatically downloaded from a data storage.

The mobile-device-specific information MDI relates to the mobile platform MP, upon which the mobile application MAPP will be executed. This information comprises information relating to the hardware MHWI of the mobile platform such as, for example, hardware version number, hardware type and hardware properties. Additionally, information relating to the operating system MOSI of the mobile platform is necessary. The mobile-device-specific information MDI is prescribed by the user or read from the mobile device MD, when the same is coupled with the application generator system for the carrying out of a generation order.

The software artifacts comprise application-specific software artifacts ADSA in the form of existing objects EOBJ, modules EMOD, components ECOM as well as services ESERV. The application-specific software artifacts ADSA are loaded from one of the data storage D1, D2 over the course of the process. Furthermore, the software artifacts include the mobile-device-specific software artifacts MDSA in the form of deployment rules MDR and dependencies MDEP between the mobile application that is to be created and operating systems as well as the hardware of the mobile device.

The application generator system APPGS includes a code generator system CGS, a deployment system DS, as well as management control system MCS.

The deployment system DS delivers information and code artifacts, namely security information, such as, for example, certificates, operating system deployment information such as, for example, deployment process artifacts for Apple® devices as well as hardware deployment information such as, for example, device information for Samsung® devices.

FIG. 2 shows a block diagram of the code generator system CGS. The code generator system CGS includes a transformation tool DADT for the transformation of the application description DAD into one or a multitude of component descriptions UICD1 . . . UICDn, DCD1 . . . UICDn, FCD1 . . . FCDn, STCD1 . . . STCDn.

The transformation tool DADT has an analyzer module DADA for the analysis of a structure as well as of contents of the application description. The analyzer module DADA breaks down the application description DAD into segments such as, for example, input prompts and display information, so as to receive user interface information. Furthermore, an application structure, an application type, an application environment as well as linker details are determined by means of the analyzer module.

The transformation tool DADT includes a component description creator CDC for the creation of the component descriptions UICD, DCD, FCD, STCD from the information made available by the analyzer module, which creates the component descriptions that are necessary for the process of the application generation from the segments, including at least one component UICD with user interface information, at least one component description DCD with data information, at least one component description FCD with function information and at least one component description STCD with structure information of the application description DAD. The creation of the component description occurs taking into account the user-specific information, mobile-device-specific information as well as the application-specific and mobile-device-specific software artifacts.

The transformation tool DADT has access to the data storage DS2, DS3 by way of the selection/download module SDLM, and automatically downloads the information and software artifacts that are necessary for the creation of the document descriptions. The desired functions can be selected by the user through the selection of the corresponding segment or component description.

The component descriptions UICD, DCD, FCD, STCD that are created by the transformation tool DADT from the application description DAD are transformed by means of a second transformation tools CDT into application components MUID, MDC, MFC, MSTC for the mobile application MAPP.

The component descriptions UICD, DCD, FCD, STCD are analyzed by means of an analysis module RCA as regards necessary application-specific software artifacts and necessary mobile-device-specific software artifacts. Software artifacts that are needed are selected by a selection/download module SDLM and downloaded from the data storage DS2, DS3.

Merely as an example, the application components include a user interface component MUIC, a data component MDC, a function component MFC as well as a structure component MSTC. The application components MUIC, MDC, MFC as well as MSTC, which were created from the analysis of the structure and the contents of the application description while taking into account the application-specific software artifacts as well as the mobile-device-specific software artifacts, form the basis for the creation of the mobile application MAPP by means of the application generator APPG. The application components include software artifacts that are, for example, downloaded from external data storage and adapted or expressed through configuration data of the concrete requirements of the mobile application.

FIG. 3 shows a flow chart of the process according to the invention. The application description DAD is transformed in the first transformations tool DADT into the necessary component description UICD, DCD, FCD as well as STCD. Following up on this, there is then an analysis of the structure and of the contents of the application description DAD by means of the analyzer module DADA. The application description DAD is broken down into segments as has been previously described. Beyond this, an application structure, an application type, and an application environment for the mobile application are created as well as linker details.

While taking into account the uploadable existing application-specific software artifacts EOBJ, EMOD, ECOM, ESERV, the mobile-device-specific software artifacts, as well as eventually a selection of segments by the user, in the next stage the necessary component descriptions UICD, DCD, FCD as well as STCD are created from the selected segments. In so doing, we are dealing with high-level-descriptions of or for application components, that are necessary for the generation. An application component can, for example, be a “TCP communication component”.

The necessary component descriptions are transformed into application components MUIC, MDC, MFC, MSTC by means of the second transformation tool CDT. Subsequently, the necessary components are analyzed as regards application-specific and mobile-device-specific software artifacts, whereby a list of existing software artifacts is created, which fulfills the general requirements of the application description. A general requirement could, for example, be the description “MODBUS-TCP PORT 2003” in the application description, from which it can be derived that a component is required that speaks “MODBUS-TCP” and is capable of producing a connection to the “Port 2003”. Inasmuch as a mobile device generally has radio communication interface, it is necessary that a mobile-device-specific software artifact be downloaded or created, which fulfills the functions “MODBUS-TCP PORT 2003” and “radio communication”. This can for example be a “Modbus-TCP.JAR” component, that is downloadable from a data storage.

In a further stage, a selection of the necessary software artifacts is undertaken and a download of the selected software artifacts is carried out, on the basis of the list of existing mobile-device-specific software artifacts and the existing application-specific software artifacts, which fulfill the requirements of the application description as well as of the mobile device. The application components are formed from the component description and/or the software artifacts while taking into account configuration files and/or software adaptations, which are automatically generated in the transformation tool.

In a further process stage, an initially empty application skeleton is preferably created in the application generator APPG from the application structure. The configuration files for the necessary application components are created from the application skeleton and from the segments of the application description inn a component configurator CC.

The application components that are configured with the configuration files are linked with the empty application skeleton with the help of a linker module LM.

The expanded application skeleton EAPPSK that has been created, which corresponds to a complete source code of a mobile application is then compiled taking into consideration the previously created application type and the application environment by means of a compiler APPC, so as to obtain a compiled mobile application CAPP.

While taking into consideration the application type as well as the application environment, the compiled mobile application CAPP is prepared for downloading by means of a deployment tool APPDH. The mobile application MAPP is thereby compatibly laid out for a mobile-device-specific operating system and a corresponding application store.

FIG. 4 shows a detailed representation of the application generator APPG. The transformation tool CDT is laid out to create an application code from the component description that results from the analysis. On top of a business logic, the application also includes functions and so-called connection points CP. The connection points CP are necessary so as to link the application skeleton APPSK that is created in the application generator APPG, with various software artifacts or alternatively components such as, for example, security components, deployment components, hardware dependency components, device functions as well as user interfaces. The security components, deployment components, hardware dependency components, device function, and/or user interfaces are add-ons, which supplement the application descriptions MUIC, MDC, MFC, in such a way that the generated software is functional and executable as a mobile application.

The connection points CP include user interface connection points UI-CP, security connection points S-CP, hardware dependency connection points HWD-CP, device function connection points DF-CP, as well as deployment connection points D-CP.

The links themselves are produced by the linker module LM with the help of various linkers. The user interface linker UI-L links the application skeleton APPSK by way of user interface-connection points UI-CPs with the user interface components UIC, which were created by a user interface-generation system UIGS. Then, the mobile application MAPP has a user interface. The user interface-generation system UIGS is an element of the code generation system CGS. User interface components are created by means of the user interface generation system UIGS, in particular, the user interface structure of the mobile application as well as the user interface for functions of the mobile application including each of the corresponding user interface codes.

The device function linker DF-L links present function components, such as special protocols such as, for example, CodeSys through the device function connection point DF-CP with the application skeleton or alternatively the expanded application skeleton. The security connection points S-CP are linked with security components such as certificates through the security linker S-L. The hardware dependency connection points HWD-CP are linked to particular hardware parts of mobile devices through the hardware dependency linker HWD-L. Through this, the mobile application, in particular, enables the use of mobile hardware such as, for example, cameras and radio networks.

It can, however, be necessary to fill out the expanded application skeleton EAPPSK, or the compiled application CAPP, with special deployment information and deployment functionalities. This is achieved through the deployment linker D-L, which links the EAPPSK or CAPP through the deployment connection points D-CP with the deployment components that are necessary for the deployment of the mobile application, such as specific deployment functions for Android or iOS based mobile applications.

All artifacts or alternatively components, which are not created through the code generator, which however are linked through a connection point, can be downloaded from the internal or external data storages DS1, DS2.

1. Process for the generation of an operating program in the form of a mobile application (MAPP) that is executable on a mobile device (MD) for interactions such as operation, monitoring, configuration and/or diagnosis with an application program (DA) of an automation device (D) for the operation and/or monitoring of a machine (M) or installation,
characterized by the fact,
that the mobile application (MAPP) is generated from an application description (DAD) of the application program (DA) of the automation device.

2. Process according to claim 1,
characterized by the fact,
that the application description (DAD) of the application program (DA) is loaded in an application generator system (APPGS),
that the application description (DAD) is analyzed as regards its structure and its contents and is broken down in segments and
that necessary component descriptions (UICD, DCD, FCD, STCD) are created out of the segments of the application description (DAD) for the generation of the mobile application (MAPP),

3. Process according to claim 2,
characterized by the fact,
that the component descriptions (UICD, DCD, FCD, STCD) are analyzed as regards the necessary application-specific software artifacts (ADSI) such as existing objects (EOBJ), existing modules (EMOD), existing components (ECOM) or existing services (ESERV) and/or necessary mobile-device-specific software artifacts (MDSA) such as deployment rules (MDR) or dependency (MDEP).

4. Process according to claim 3,
characterized by the fact,
that the necessary application-specific software artifacts (ADSI, EOBJ, EMOD, ECOM, ESERV) and/or mobile-device-specific software artifacts (MDSA, MDR, MDEP) are selected and are downloaded from a data storage (DS1, DS2),
that application components (MUIC, MDC, MFC, MSTC) are created from the necessary application-specific software artifacts (ADSA, EOBJ, EMOD, ECOM, ESERV) and/or the mobile-device-specific software artifacts (MDSA, MDR, MDEP), and
that an executable source code for the mobile application (MAPP) is generated out of the application components (MUIC, MDC, MFC, MSTC).

5. Process according to claim 2,
characterized by the fact,
that during the analysis of the application description (DAD), an application structure of the mobile application (MAPP), an application type, an application environment and/or linker details are derived, whereby an initially empty application skeleton (APPSK) is created out of the application structure and that configuration files for the application components (MUIC, MDC, MFC, MSTC) are created in dependence of the application skeleton (APPSK) and of the component descriptions (UICD, DCD, FCD, STCD).

6. Process according to claim 4,
characterized by the fact,
that the executable code of the mobile application (MAPP) is created through the linking of the application components (MUIC, MDC, MFC, MSTC) with the application skeleton.

7. Process according to claim 1,
characterized by the fact,
that during the generation of the mobile (MAPP) user-specific information (CSI) such as corporate identity, manufacturer name or username arid/or mobile-device-specific information (MDI) such as information relating to the hardware (MHWI) or relating to the mobile operating system (MOSI) are requested by an input prompt or are read from the application description (DAD) or from the mobile device (MD) in the case of linking with the application generator system (APPGS).

8. Process according to claim 2,
characterized by the fact,
that following the process stage of the analysis of the application description (DAD), those component descriptions (UICD, DCD, FCD, STCD) are selected by a user, are described by the user interfaces, functions, data and/or structures that are required for the interaction of the mobile application (MAPP) with the application program (DA) that is running on the automation device (D).

9. Process according to claim 8,
characterized by the fact,
that the component descriptions (UICD, DCD, FCD, STCD) include at least one user interface component description (UICD), one data component description (DCD), one function component description as well as a structure component description (STCD).

10. Process according to claim 1,
characterized by the fact,
that an XML description is used as application description (DAD) of the application program (DA).

11. Application generator system for generation of an operating program in the form of a mobile application (MAPP) that is executable on a mobile device (MD) for interaction such as, for example, operation, monitoring, configuration and/or diagnosis with an application program (DA) of an automation device (D) for the control and/or monitoring of a machine (M) or installation
characterized by the fact,
that the application generator system features a code generator system (CGS) with at least one transformation tool (DADT, CDT) for the transformation of an application description (DAD) of the application program (DA) of the automation device (D) into application components (MUIC, MDC, MFC, MSTC) and an application generator (APPG) for the generation of the mobile application (MAPP) on the basis of the application components (MUIC, MDC, MFC, MSTC).

12. Application generator system according to claim 11,
characterized by the fact,
that the code generator system (CGS) includes a first transformation tool (DADT) for the transformation of the application description (DAD) of the application program (DA) into one a multitude of component descriptions (UICD, DCD, FCD, STCD) as well as a second transformation tool (CDT) for the transformation of the component descriptions (UICD, DCD, FCD, STCD) into the application components (MUIC, MDC, MFC, MSTC) while taking into consideration application-specific software artifacts (ADSA, EOBJ, EMOD, ECOM, ESERV) and/or mobile-device-specific software artifacts (MDSA, MDR, MDEP).

13. Application generator system according to claim 12,
characterized by the fact,
that the first transformation tool (DADT) includes: an analysis module (DADA) for the analysis of a structure and the contents of the application description (DAD) and for the breaking down of the application description (DAD) into segments as well as a component description creator (CDC) for the creation of the component descriptions (UICD, DCD, FCD, STCD) from the segments, whereby the component descriptions (UICD, DCD, FCD, STCD) include at least one user interface component description (UICD), one data component description (DCD), one function component description as well as one structure component description (STCD).

14. Application generator system according to claim 12,
characterized by the fact,
that the first transformation tool (DADT) features a selection/download module (SDLM) for the selection and/or for the downloading of external user-specific information (CSI) and/or mobile-device-specific information (MDI) as well as for the selection and for the downloading of user-specific software artifacts (ADSA, EOBJ, EMOD, ECOM, ESERV) as well as mobile-device-specific software artifacts (MDSA, MDR, MDEP).

15. Application generator system according to claim 12,
characterized by the fact,
that the second transformation tool (CDT) includes: an analysis module (RCA) for the analysis of the required component descriptions (UICD, DCD, FCD, STCD) as regards existing user-specific software artifacts (ADSA, EOBJ, EMOD, ECOM, ESERV) as well as mobile-device-specific software artifacts (MDSA, MDR, VIDEO), a selection/download module (SDLM) for the selection for downloading of the required user-specific software artifacts (ADSA, EOBJ, EMOD, ECOM, ESERV) as well as mobile-device-specific software artifacts (MDSA, MDR, MDEP) from the at least one data storage (DS1, DS2, DS3).

16. Application generator system according to claim 11,
characterized by the fact,
that the application generator (APPG) includes an application skeleton generator (APPSKG), a configuration file generator (CFG) as well as linker module (LM), whereby the application skeleton generator creates an initially empty application skeleton from the application structure that is derived from one of the application descriptions, the configuration file generator creates configuration files for the application components from the component descriptions in connection with the application skeleton, and whereby the linker module links the configured application components with the application skeleton for creation of the executable codes of the mobile application (MAPP).

17. Application generator system according to claim 11,
characterized by the fact,
that the mobile device (MD) is a smart device such as, for example, a smartphone or a tablet computer.
